(19) United States
(12) Patent Application Publication
(10) Pub. No.: US 2005/0016753 A1
(43) Pub. Date: Jan. 27, 2005

(54) Flat cable tubing

(76) Inventor: Helmut Seigerschmidt, Fiegenstall-Hottingen (DE)

Correspondence Address: GORE ENTERPRISE HOLDINGS, INC., 551 PAPER MILL ROAD, P. O. BOX 9206, NEWARK, DE, 19714-9206, US

(21) Appl. No.: 10/891,639

(22) Filed: Jul. 15, 2004

Related U.S. Application Data
(63) Continuation of application No. 09/570,773, filed on Sep. 15, 2000, now abandoned.
Application No. 09/570,773 is a continuation-in-part of application No. 09/148,653, filed on Sep. 4, 1998, now abandoned.

(30) Foreign Application Priority Data
Sep. 19, 1997 (EP) 9711639

(51) Int. Cl. H01B 7/18

(52) U.S. Cl. 174/106 R; 174/117 F

(57) ABSTRACT

The invention discloses an electrical signal cable assembly (10, 110, 210, 710) with a plurality of subcable assemblies (20, 120, 220, 320, 620, 720) stacked on each other. Each subcable assembly (20, 120, 220, 320, 630, 720) includes a plurality of coplanar electrical signal conductors (30, 130, 230, 330, 730) encased within an insulator (40a, 40b) and which are separated from each other by a first pitch distance (a), whereby the first pitch distance (a) is between 0.1 mm and 10 mm. The characteristic impedance of the electrical signal cable assembly (10, 110, 210, 710) is in the range of 50 Ω to 200 Ω. I the preferred embodiment of the electrical signal cable assembly (10, 110, 210, 710) the insulator (40a, 340a, 640a, 740a, 40b, 640b, 740b) comprises an upper insulator (40a, 340a, 640a, 740a) laminated to a lower insulator (40b, 340b, 640b, 740b) and is made from expanded polytetrafluoroethylene.

### RELATED APPLICATIONS

This application is a continuation of U.S. patent application Ser. No. 09/570,773, which is a Continuation in part of application Ser. No. 09/148/653 filed Sep. 4, 1998.

### FIELD OF THE INVENTION

The invention relates to an electrical signal line cable assembly.

### PRIOR ART

Electrical signal lines are known, for example, from European Patent Application EP-A-0 735 544 (Cartier et al.) assigned to Hewlett-Packard Company. This patent application describes an ultrasound system with a transducer cable for providing an electrical connection between a transducer and a display processor. The third embodiment of the transducer cable in this application uses three layers of extruded ribbon assemblies separated from each other by shield conductors comprising thin strips of bare copper. The stack of ribbon assemblies and shield conductors are extruded with a ribbon jacket to form a desired length of the transducer cable.

U.S. Pat. No. 4,847,443 (Basconi) assigned to the Amphenol Corporation teaches another example of an electrical signal line cable formed from a plurality of generally flat electrical signal line segments stacked together in an interlocking relationship. Each electrical signal line segment of this prior art cable contains at least one signal conductor surrounded on either side by ground conductors. The plurality of ground conductors effectively form a ground plane which inhibit the cross-talk between the adjacent signal conductors. The insulating materials in which the conductors are disposed is extruded over the individual signal conductors.

European Patent EP-B-0 605 600 (Springer et al.) assigned to the Minnesota Mining and Manufacturing Company teaches a ribbon cable and a lamination method for manufacturing the same. The ribbon cable manufactured comprises a plurality of evenly spaced flexible conductors surrounded by an insulator which is a microporous polypropylene.

US Patent U.S. Pat. No. 4,847,443 (Crawley et al.) assigned to W. L. Gore & Associates teaches a multi-conductor flat ribbon cable having a plurality of electrical conductors disposed within an insulator consisting of expanded polytetrafluoroethylene (ePTFE).

PCT patent application WO-A-91/09406 (Ritchie et al) teaches an electrical wiring composed of elongated electrically conductive metal foil strips laminated between opposing layers of insulating films by means of adhesive securing the foil strips between the laminating films.

German patent application DE-A-24 24 442 assigned to Siemens teaches a cable assembly which comprises a plurality of flat cables laminated between insulating films.

PCT patent application WO-A-80/00389 (Clarke) assigned to Square D company of Palatine, Ill., teaches an input/output data cable for use with programmable controllers. The cable has a ground conductor, a logic level voltage conductor and a number of signal tracks. The conductors are disposed on two or three layers of flexible plastics material in specified ways to give high immunity to interference and low inductive losses. The layers are glued together to form a laminate structure.

W. L. Gore & Associates, Inc., Newark, Del., sell a round cable under the part number 02-07605 which comprises 132 miniature co-axial cables enclosed within a braided shield of tin-plated copper and a jacket tube of PVC.

There remains a need in the art to develop an electrical signal cable assembly having a plurality of ribbon cables which is light in weight, offers adequate performance characteristics and reduces the complexity of termination.

### SUMMARY OF THE INVENTION

It is therefore an object of this invention to develop an improved signal cable assembly.

It is furthermore an object of the invention to develop a signal cable assembly having a plurality of ribbon cables which have a high impedance and low capacitance

It is furthermore an object of this invention to simplify the termination of a signal cable assembly.

It is furthermore an object of this invention to develop a signal cable assembly having a plurality of ribbon cables which is light in weight compared to a comparable assembly of miniature coaxial cables.

These and other objects of the invention are achieved by providing an electrical signal cable assembly comprising at least one ribbon cable arranged in at least one first concentric array around a cylindrical spacer. A separating concentric element disposed about the first concentric array and at least one further ribbon cable is arranged in at least one further concentric array about the separating concentric element.

The separating concentric element can be either formed from a dielectric spacer, a conducting plane or a combination of the two. Its role is many-fold. It is used to improve the signal isolation and reduce cross-talk between the concentric arrays. The dielectric spacer is used to increase the impedance and thus reduce the capacitance. The conducting plane is used as a ground plane to further reduce the cross-talk between the ribbon cables in different concentric arrays.

One embodiment of the invention uses a ribbon cable as a separating concentric element in which all of the electrical conductors within the ribbon cable are connected to AC ground potential. This construction has the advantage compared to the use of a metal ground plane in that during flexing of the cable the generation of tribostatic charge between the separating concentric element and the ribbon cable is eliminated. As is known, tribostatic charges are generated when conducting metal material rubs against a dielectric insulator. The tribostatic charges generate signal noise within the electrical signal cable assembly which degrade the quality of the signals carried on the assembly. Since the use of a ribbon cable as a separating concentric element ensures that the dielectric insulating material of the separating concentric element rubs against the same or similar dielectric insulating material of the ribbon cable in one of the concentric arrays, there are no tribostatic charges generated in This embodiment of the cable and consequently the signal-carrying capability of the electrical signal cable assembly is enhanced.

In one embodiment of the invention, at least some of the ribbon cables of the concentric arrays are made up of a plurality of electrical conductors, some of which are connectable to AC ground potential and others to signals. The connection of at least some of the electrical conductors to AC ground potential within the same ribbon cable as those signal-carrying conductors is that the AC ground-carrying conductors shield the signal-carrying conductors from each other and thus reduce the cross-talk between the signal-carrying conductors within the same ribbon cable. The term AC ground means that the AC ground carrying conductors do not carry an alternating signal but rather an invariable voltage level which may or may not be at zero volts.

In some of the concentric arrays, two or more ribbon cables are placed adjacent to each other. This improves the flexibility of the electrical signal cable assembly since narrower ribbon cables can be used which move within the same concentric array relative to each other and thus contribute to the flexibility of the cable.

The ribbon cables in the electrical signal cable assembly are served about the cylindrical spacer and in the first as well as in the subsequent further concentric arrays. It is also conceivable to braid the cables or wrap them in other manners. The ribbon cables can be served in the same direction in all of the concentric arrays or they can be opposedly served in adjacent concentric arrays.

It is advantageous to serve the separating concentric element in an opposed manner to the ribbon cables in the adjacent concentric arrays since this will enhance the ability of the separating concentric element to maintain the stability of the ribbon cables.

In the electrical signal cable assembly an outer shield is preferentially disposed about the further concentric array to act as an electromagnetic shield for shielding the electrical conductors within the electrical signal cable assembly from extraneous signals. Furthermore an outer binder can be disposed between the further concentric array and the outer shield to hold the ribbon cables within the electrical signal cable assembly in place.

A jacket is disposed about the outside of electrical signal cable assembly to protect the electrical signal cable assembly from mechanical damage.

The electrical signal cable assembly can have more than two concentric arrays. Each of the concentric arrays is separated from each other by further concentric separating elements.

The electrical signal cable assembly can incorporate within the first concentric array a strain relief or a strength member to improve the longitudinal strength of the assembly. Furthermore, an insulated wire signal or signal coaxial cables can be incorporated within the cylindrical spacer which can carry, for example, power or further signals along the assembly. In such cases it is advantageous to incorporate an inner cylindrical shield between said insulated wire and said at least one first concentric array to shield the signal-carrying conductors within the first concentric array from any electromagnetic field generated by the insulated wire. Alternatively, the cylindrical spacer forms a hollow tube.

The insulator material of the ribbon cable can be made from the group of insulating materials consisting of perfluoralkoxy, fluoroethylene-propylene, polyester, polyolefin including polyethylene and polypropylene, polymethylpentene, full density polytetrafluoroethylene and is most preferably made from expanded polytetrafluoroethylene. Foamed or extruded polymers can also be used.

The ribbon cable is preferably made from an upper and lower insulator which are both made from an upper and lower insulator which are both made of expanded PTFE and which are sintered to each other.

### DESCRIPTION OF THE DRAWINGS

FIG. 1 shows the electrical signal line cable according to a first embodiment of the invention.

FIG. 2 shows a device for the manufacture of the ribbon cables in the electrical signal line cable.

FIG. 3 shows a sintering device used in the manufacture of the ribbon cables.

FIG. 4 shows the electrical signal cable according to a second embodiment of the invention.

FIG. 5 shows an end view of the electrical signal cable of the second embodiment of the invention.

FIG. 6 shows the electrical signal cable according to a third embodiment of the invention.

FIG. 7 shows the electrical signal cable according to a fourth embodiment of the invention.

FIG. 8 shows the electrical signal cable according to a fifth embodiment of the invention.

FIG. 9 shows the electrical signal cable according to a sixth embodiment of the invention.

FIG. 10 shows the electrical signal cable according to a seventh embodiment of the invention.

FIG. 11 shows the electrical signal cable according to an eighth embodiment of the invention.

### DETAILED DESCRIPTION OF THE INVENTION

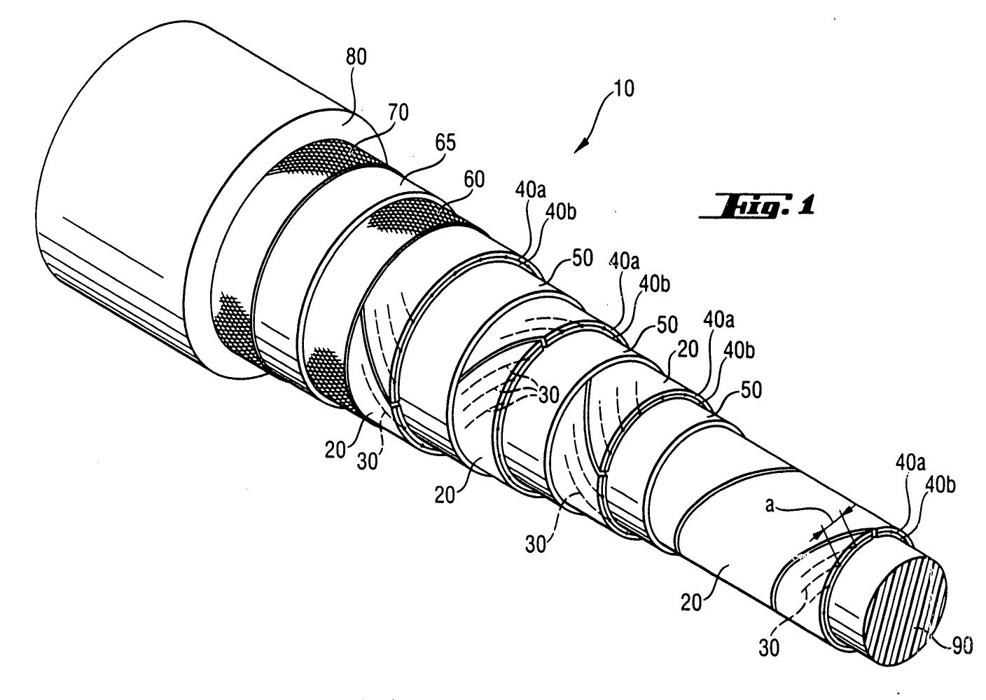

FIG. 1 shows a first embodiment of the invention. It shows an electrical signal line 10 comprising a plurality of ribbon cables 20 helically wrapped about a cylindrical spacer 90. Each layer or valence of ribbon cables 20 is separated by a separating spacer 50. In FIG. 1 four valences of sub cable assemblies 20 are shown. However, this is merely illustrative of the invention and not intended to be limiting.

Each ribbon cable 20 comprises a plurality of individual signal conductors 30 arranged in a plane and surrounded by an upper insulating layer 40a and a lower insulating layer 40b. The upper insulating layer 40a and the lower insulating layer 40b are laminated together as will be explained later. The individual signal conductors 30 can be made from any conducting material such as copper, nickel-plated copper, tin-plated copper, silver-plated copper, tin-plated alloys, silver-plated alloys or copper alloys. Preferably the individual signal conductors 30 are made of round copper wire. It would also be possible to use flat conductors.

The number of individual signal conductors 30 depicted in FIG. 1 is not intended to limiting of the invention. The axes of the individual signal conductors 30 are separated in the plane by a first pitch distance a which is in the range of 0.1 to 1 mm. The upper insulating layer 40a and the lower insulating layer 40b can be made of any insulating dielectric material such as polyethylene, polyester, perfluoralkoxy, fluoroethylene-propylene, polypropylene, polymethylpentene, polytetrafluoroethylene or expanded polytetrafluoroethylene. Preferably expanded polytetrafluoroethylene such as that described in U.S. Pat. No. 3,953,556, U.S. Pat. No. 4,187,390 or U.S. Pat. No. 4,443,657 is used.

The separating spacer 50 is made, for example, from a metal foil, metal braid, conductive tape, a metallized textile or a dielectric spacer. The following metals can be used: copper, tin, silver, aluminum or alloys thereof. The dielectric spacer can be made from dielectric materials such as polyethylene, perfluoralkoxy, fluoroethylene-propylene, polypropylene, polymethylpentene, polytetrafluoroethylene or expanded polytetrafluoroethylene (ePTFE).

In one embodiment of the invention the separating spacer 50 was made from copper-coated polyamide fabric of the Kassel type supplied by the Statex company in Hamburg, Germany, and had a thickness of approximately 0.1 mm and a width of around 9 mm. In another embodiment of the invention, the separating spacer 50 was made from ePTFE. Separating spacers 50 which comprise a layer of a dielectric material and a layer of conducting material are also conceivable.

A first shielding means 60 is wrapped about the arrays of the ribbon cables 20. An insulating layer 65 was then wrapped around the first shielding means 60 using known wire wrapping techniques. The insulating layer 65 may be made, for example, from PTFE, FEP, ePTFE or polyester. Preferably the insulating layer 65 is made from sintered GORE-TEX® tape which is obtainable from W. L. Gore & Associates.

A second shielding means 70 surrounds the insulating layer 65. The first shielding means 60 and the second shielding means 70 are a braid, foil or wire shield made from a metal or a metallized polymer, such as copper, aluminum, tin-plated copper, silver-plated copper, nickel-plated copper or aluminized polyester.

A jacket 80 is placed over the second shielding means 70. The jacket 80 is made from silicone or polyolefins such as polyethylene, polypropylene or polyethylpentene; fluorinated polymers such as fluorinated ethylene/propylene (FEP); fluorinated alkoxypolymer such as perfluoro(alkoxy)alkylanes, e.g. a co-polymer of TFE and perfluoropropylvinyl ether (PFA); polyurethane, polyvinyl chloride (PVC) or polytetrafluoroethylene (PTFE) or expanded PTFE. In one embodiment of the invention the jacket 80 was made from PVC.

The cylindrical spacer 90 is made from ePTFE, PTFE, polyamide, polyurethane, persion or any other suitable material. The cylindrical spacer 90 may be solid or have a hollow interior to carry cooling fluids, electrical control or power lines, gases etc. The cylindrical spacer 90 may be made from a braided or stranded material. The cylindrical spacer 90 can incorporate a strain relief and/or strength member. The term “cylindrical” does not imply that the cylindrical spacer 90 needs to be exactly cylindrical, rather it only needs to be substantially cylindrical to the extent that it acts as a support for the ribbon cables 20.

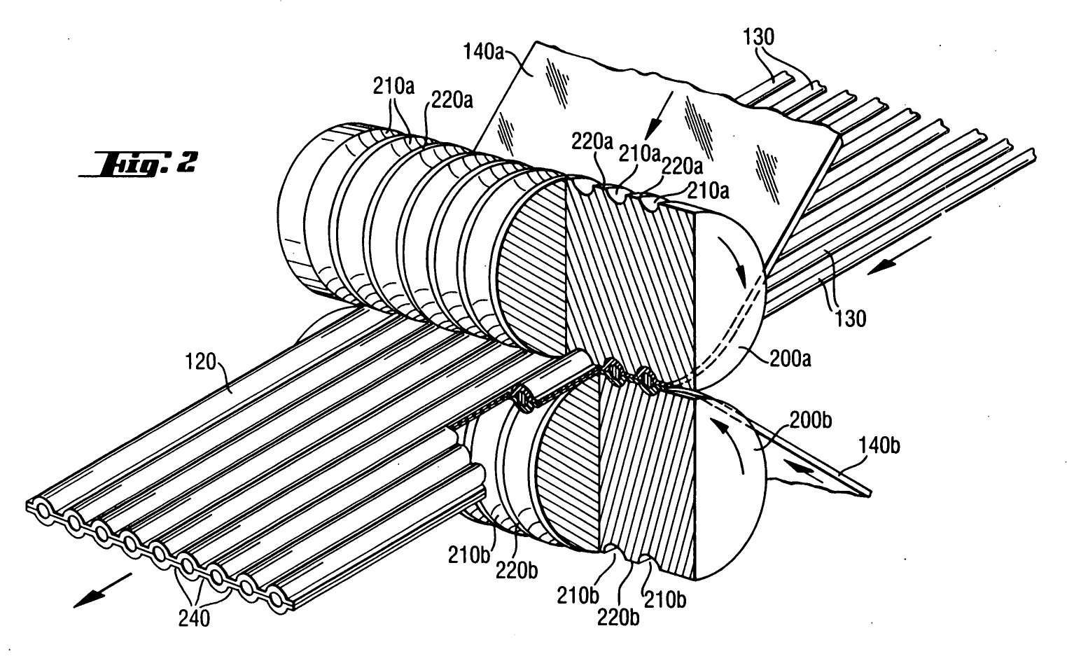

Manufacture of the ribbon cables 20 is illustrated in FIG. 2 for the embodiment in which the upper insulating layer 140a and the lower insulating layer 140b are made from expanded PTFE. This method is essentially the same as that taught in U.S. Pat. No. 3,082,292 (Gore). The same reference numerals are used to denote the components of the ribbon cable 20 (120) as those used for the components of the ribbon cable 20 in the first embodiment of the invention (FIG. 1) except that they are increased by 100. A plurality of individual signal conductors 130, an upper insulator 140a located above the plurality of individual signal conductors 130, and a lower insulator 140b located below the plurality of individual signal conductors 130 were communally passed between two contra-rotating pressure rollers 200a and 200b at a lamination temperature sufficient to achieve bonding between the lower insulator 140b and the upper insulator 140a, e.g. between 327° C. and 410° C. A ribbon cable 120 was thereby formed. For this purpose, the upper pressure rollers 200a is provided with a number of upper peripheral grooves 210a each separated by an upper peripheral rib 220a which are lined up at a distance from one another along the circumference of the pressure rollers 200a. Similarly, the lower pressure rollers 200b is provided with a number of lower peripheral grooves 210b each separated by a lower peripheral rib 220b which are lined up at a distance from one another along the circumference of the pressure roller 200b. Each upper peripheral groove 210a of the upper pressure roller 200a together with the adjacent upper peripheral ribs 220a lines up with one of the lower peripheral grooves 210b with the adjacent lower peripheral ribs 220b of the lower pressure roller 200b to form a passageway channel for one of the individual signal conductors 130. The distance between the two pressure rollers 200a, 200b and the peripheral grooves 210a, 210b are designed in terms of their dimensions in such a way that a single conductor 130 and the upper insulator 140a and the lower insulator 140b pass continuously between a pair consisting of one of the upper peripheral grooves 210a and one of the lower peripheral grooves 210b. The upper peripheral ribs 220a and the lower peripheral ribs 220b have such a small separation from one other that the upper insulator 140a and the lower insulator 140b are firmly pressed together at these positions to form an intermediate zone 240 in the ribbon cable 120.

In order to improve their adhesion of the upper insulator 140a to the lower insulator 140b to the individual signal conductors 130 and with each other within the ribbon cable 120, the ribbon cable 120 was led through a sintering device in which the ribbon cable 120 is heated such that one achieves intimate joining in the intermediate zones 240 of the ribbon cable 120. If using an upper insulator 140a and a lower insulator 140b made of PTFE, use is made of a sintering temperature in the range from 327° to 410° C.

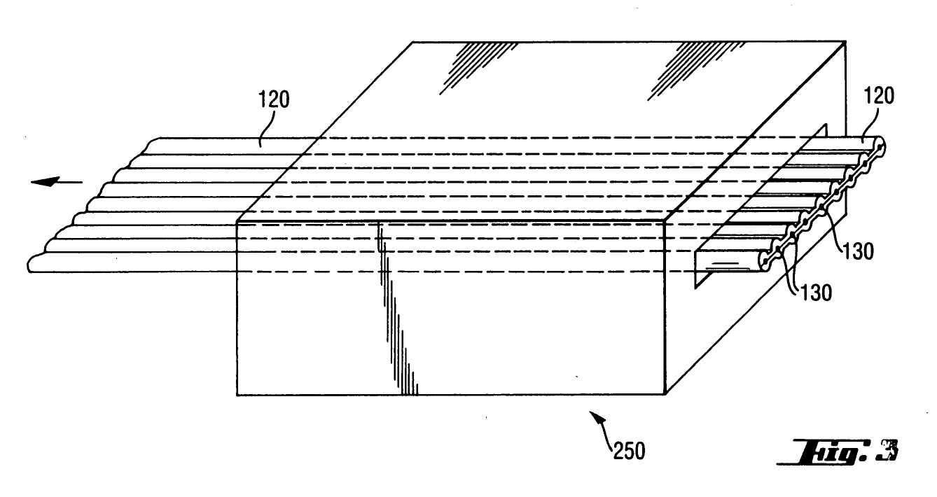

An example of an embodiment of a sintering device in the form of a sintering oven 250 comprising a salt bath is illustrated in a schematic and simplified form in FIG. 3. In this example, the ribbon cable 120 is continually passed through the sintering over 250.

Tests

Tests were carried out on electrical signal cable assemblies of 2.0 m or 2.5 m length.

To check the electrical characteristics of the assemblies, all ribbon cables within the cables were terminated to printed circuit boards. All of the ground conductors within the cable were connected together at a common AC ground.

The measurement for impedance, capacitance and attenuation were carried out on a single signal conductor. All other signal conductors were open. For the other tests, the signal conductors were terminated by a resistor.

The torsion test was carried out by gripping one end of a cable assembly firmly and measuring the torque required to turn the cable both clockwise and anti-clockwise at the other end of the cable assembly.

### EXAMPLES

The examples below illustrate cable constructions that can be made using the invention. The ribbon cables used had either 16, 24 or 32 individual conductors which were made from PD 135 alloy obtainable from Phelps Dodge in Irvine, Calif., USA. In Examples 1 to 4 and 6, conductors of AWG 4201 were used and the conductors were spaced 0.254 mm apart. In Example 5, conductors of AWG 4001 were used spaced 0.3556 mm apart. The ribbon cables were served at angles between 30° and 35°.

The individual conductors were laminated using the method described between a first insulation layer and a second insulation layer made of ePTFE. In Examples 1 to 4 and 6, the insulation layers were each 0.0762 mm thick. In Example 5, the insulation layers were each 0.1016 mm thick.

The binders used were made of ePTFE and were made from a tape of 0.08 mm thickness. These were wrapped over each other to give an average total thickness of the layer of 0.12 mm. The binders were wrapped at angles between 30° and 38° in a direction opposite to that of the flat cables.

The outer shields used in examples 1 to 7 were made from tin plated copper wire of AWG 4401. In example 8, silver-plated copper wire of AWG 4401 was used.

The outer jacket was made from extruded PVC and had a thickness of 0.76 mm.

### Example 1

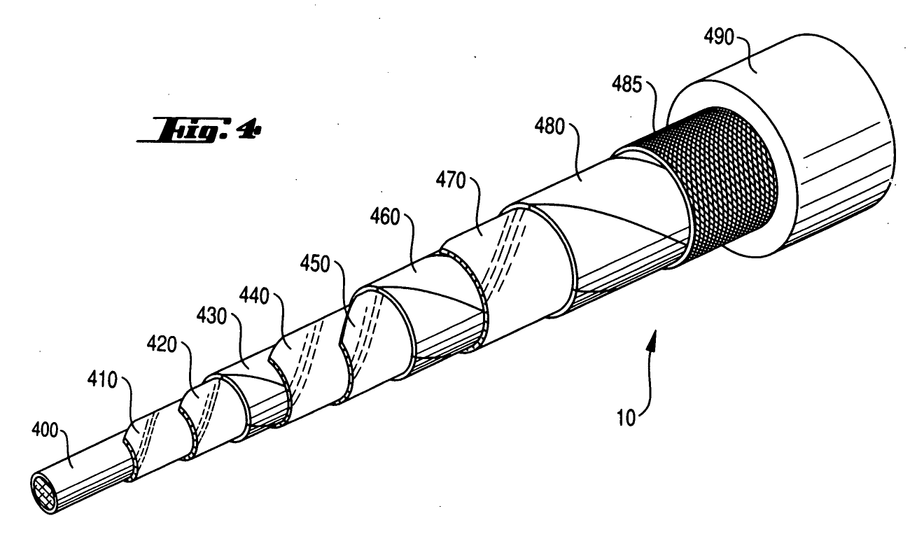

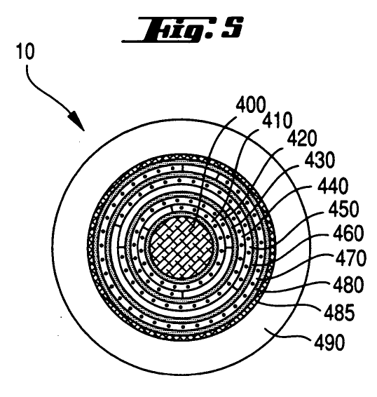

A 48 element cable 10 made in accordance with the invention is depicted in FIGS. 4 and 5. The spacer 400 was made of woven Kevlar yarn over which was extruded a PVC layer. It had a nominal outside diameter of 1.5±0.1 mm. A first flat cable 410 was wrapped in a first direction about the spacer 400. A second flat cable 420 was wrapped about the first ribbon cable 410. A first binder 430 made of ePTFE and having a thickness of 0.12 mm was wrapped in an opposite direction about the second flat cable 420. A third flat cable 440 was wrapped about the first binder 430 as the second flat cable 420. A fourth flat cable 450 was wrapped about the third flat cable 440. A second binder 460 was wrapped about the fourth flat cable 450 in the opposite direction to the fourth flat cable 450. A fifth flat cable 470 was wrapped about the second binder 460 in the opposite direction to the second binder 460 and thus as the first flat cable 410 and the second flat cable 420. A third binder 480 was wrapped about the fifth flat cable 470. An outer shield 485 was placed over the fifth flat cable 480 and a jacket 490 extruded over the outer shield 485. The outer shield 485 was made by braiding wire at a braiding angle of 19° using 16 bobbins and 13 ends at 6 picks per inch (2.54 cm).

In this example, the first flat cable 410, the second flat cable 420, the third flat cable 440, the fourth flat cable 450 were made with 16 individual conductors. The fifth flat cable 470 was made with 32 individual conductors.

The cable had a nominal outside diameter of 5.5 mm.

### Example 2

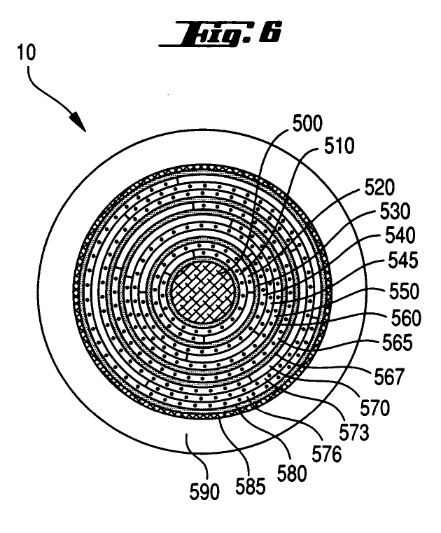

A 96 element cable 10 made in accordance with the invention is depicted in FIG. 6. The spacer 500 was made of woven Kevlar yarn over which was extruded a PVC layer. It had a nominal outside diameter of 1.5±0.1 mm. A first flat cable 510 was wrapped about the spacer 500. A second flat cable 520 was wrapped in the same direction about the first ribbon cable 510. A first binder 530 was wrapped in an opposite direction about the second flat cable 520. A third flat cable 540 was wrapped in the opposite direction about the first binder 530. A fourth flat cable 545 was wrapped in the same direction about the third flat cable 540. A fifth flat cable 550 was wrapped in the same direction about the fourth flat cable 545. A second binder 560 was wrapped in the opposite direction about the fifth flat cable 550. A sixth flat cable 565 was wrapped in the opposite direction about the second binder 560. A third binder 567 was wrapped in the opposite direction about the sixth flat cable 565. A seventh flat cable 570 was wrapped in the opposite direction about the third binder 567. An eighth flat cable 573 was wrapped in the same direction about the seventh flat cable 570. A ninth flat cable 576 was wrapped in the same direction about the eight flat cable 573. A fourth binder 580 was wrapped in the opposite direction about the ninth flat cable 576. The outer shield 585 was placed over the fourth binder 580 and a jacket 590 extruded over the outer shield 585. The outer shield 585 was made by braiding wire at a braiding angle of 19.5° using 16 bobbins and 26 ends at 4.5 picks per inch (2.54 cm).

In this example, the first flat cable 510, the second flat cable 520, the third flat cable 540 were made with 16 individual conductors. The fourth flat cable 545 and the fifth flat cable 550 were made with 24 individual conductors. The sixth flat cable 565, the seventh flat cable 570, the eighth flat cable 573 and the ninth flat cable 576 were made with 32 individual conductors.

The cable 40 had a nominal outside diameter of 6.9 mm.

### Example 3

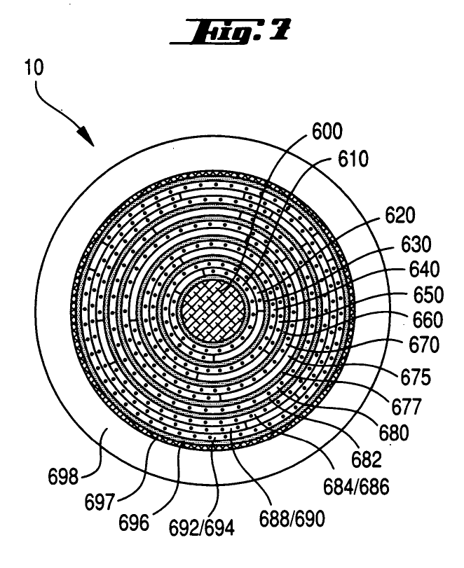

A 128 element cable 10 made in accordance with the invention is depicted in FIG. 7. The spacer 600 was made of woven Kevlar yarn over which was extruded a PVC layer. It had a nominal outside diameter of 1.5±0.1 mm. A first flat cable 610 was wrapped about the spacer 600. A second flat cable 620 was wrapped in the same direction about the first ribbon cable 610. A first binder 630 made of ePTFE was wrapped in the opposite direction about the second flat cable 620. A third flat cable 640 was wrapped in the opposite direction about the first binder 630. A fourth flat cable 650 was wrapped in the same direction about the third flat cable 640. A second binder 660 was wrapped about the fourth flat cable 650. A fifth flat cable 670 was wrapped in the opposite direction about the second binder 660. A sixth flat cable 675 was wrapped about the fifth flat cable 670. A third binder 677 was wrapped in the opposite direction about the sixth flat cable 675. A seventh flat cable 680 was wrapped about the third binder 677. A fourth binder 682 was wrapped in the opposite direction about the seventh flat cable 680. An eight flat cable 684 and a ninth flat cable 686 were wrapped adjacent to each other side by side in the same cylindrical plane about the fourth binder 682. A tenth flat cable 688 and an eleventh flat cable 690 were wrapped in the same direction adjacent to each other about the eighth flat cable 684 and the ninth flat cable 686. A twelfth flat cable 692 and a thirteenth flat cable 694 were wrapped in the same direction about the tenth flat cable 688 and the eleventh flat cable 690. A fifth binder 696 was wrapped in the opposite direction about the twelfth flat cable 692 and the thirteenth flat cable 694.

An outer shield 697 was placed over the fifth binder 696 and a jacket 698 extruded over the outer shield 697. The outer shield 697 was made by braiding wire at a braiding angle of 20° using 16 bobbins and 26 ends at 4 picks per inch (2.54 cm).

In this example, the first flat cable 610, the second flat cable 620, the eighth flat cable 684, the tenth flat cable 688 and the twelfth flat cable 692 were made of 16 individual conductors. The third flat cable 640, the fourth flat cable 650, the fifth flat cable 670, the sixth flat cable 675 and the eleventh flat cable 690 were made with 24 individual conductors. The seventh flat cable 680 and the thirteenth flat cable 694 were made with 32 individual conductors.

In operation the seventh flat cable 680 was designed such that the individual conductors are placed at ground.

### Example 4

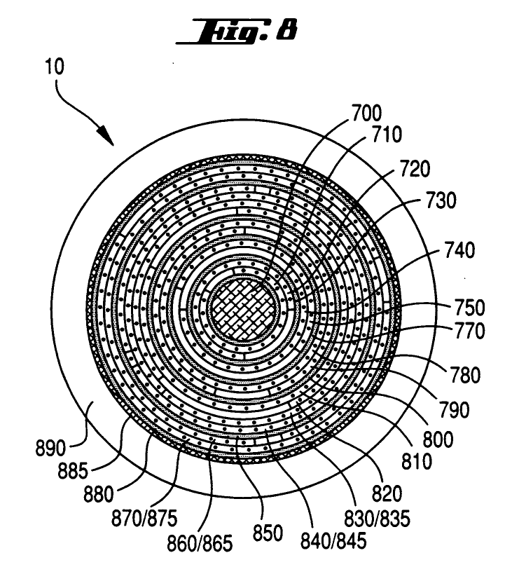

A 196 element cable 10 made in accordance with the invention is depicted in FIG. 8. The spacer 700 was made of woven Kevlar yarn over which was extruded a PVC layer. It had a nominal outside diameter of 1.5±0.1 mm. A first flat cable 710 was wrapped about the spacer 700. A second flat cable 720 was wrapped in the same direction about the first ribbon cable 710. A first binder 730 was wrapped in the opposite direction about the second flat cable 720. A third flat cable 740 was wrapped in the opposite direction about the first binder 730. A fourth flat cable 750 was wrapped about the third flat cable 740. A second binder 770 was wrapped in the opposite direction about the fourth flat cable 750. A fifth flat cable 780 was wrapped in the opposite direction about the second binder 770. A sixth flat cable 790 was wrapped in the same direction about the fifth flat cable 780. A third binder 800 was wrapped in the opposite direction about the sixth flat cable 790. A seventh flat cable 810 was wrapped in the opposite direction about the third binder 800. An eighth flat cable 820 was wrapped about the seventh flat cable 810. In the next layer, two flat cables, a ninth flat cable 830 and a tenth flat cable 835 were wrapped in the same direction adjacent to each other. Subsequently an eleventh flat cable 840 and a twelfth flat cable 845 were wrapped in the same direction in the same layer adjacent to each other. A fourth binder 850 was wrapped in the opposite direction about the eleventh flat cable 840 and the twelfth flat cable 845. A thirteenth flat cable 860 and a fourteenth flat cable 865 were subsequently wrapped in the opposite direction about the fourth binder 850 adjacent to each other. A fifteenth flat cable 870 and a sixteenth flat cable 875 were wrapped in the same direction adjacent to each other about the thirteenth flat cable 860 and the fourteenth flat cable 865. A fifth binder 880 was wrapped in the opposite direction about the fifteenth flat cable 870 and the sixteenth flat cable 875.

The outer shield 885 was placed over the fifth binder 880 and a jacket 890 extruded over the outer shield 885. The outer shield 885 was made by braiding wire at a braiding angle of 22.5° using 16 bobbins and 26 ends at 4 picks per inch (2.54 cm).

In this example, the first flat cable 710, the second flat cable 720, the third flat cable 740, the fourth flat cable 750, the ninth flat cable 830, the eleventh flat cable 840, the thirteenth flat cable 860 and the fifteenth flat cable 870 were made of 16 individual conductors. The fifth flat cable 780, the sixth flat cable 790, the seventh flat cable 810, the eighth flat cable 820, the tenth flat cable 835, the twelfth flat cable 845, the fourteenth flat cable 865 and the sixteenth flat cable 875 were made with 32 individual conductors.

### Example 5

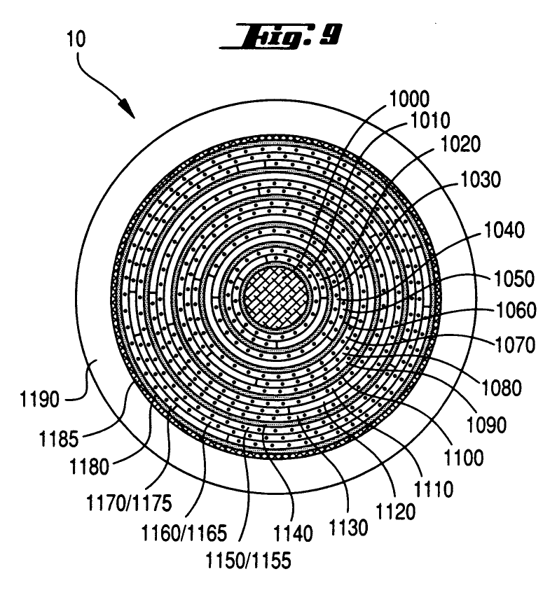

A 196 element cable 10 made in accordance with the invention is depicted in FIG. 9. The spacer 1000 was made of woven Kevlar yarn over which was extruded a PVC layer. It had a nominal outside diameter of 2.1±0.1 mm. A first flat cable 1010 was wrapped about the spacer 1000. A second flat cable 1020 was wrapped in the same direction about the first flat cable 1010. A first binder 1030 was wrapped in the opposite direction about the second flat cable 1020. A third flat cable 1040 was wrapped in the opposite direction about the first binder 1030. A fourth flat cable 1050 was wrapped in the same direction about the third flat cable 1040. A second binder 1060 was wrapped in the opposite direction about the fourth flat cable 1050. A fifth flat cable 1070 was wrapped in the opposite direction about the second binder 1060 and thus as the first flat cable 1010 and the second flat cable 1020. A sixth flat cable 1080 was wrapped about the fifth flat cable 1070. A seventh flat cable 1090 was wrapped in the same direction about the sixth flat cable 1080. A third binder 1100 was wrapped in the opposite direction about the seventh flat cable 1090. An eighth flat cable 1110 was wrapped in the opposite direction about the third binder 1100. A ninth flat cable 1120 was wrapped in the same direction about the eight flat cable 1110. A tenth flat cable 1130 was wrapped in the same direction about the ninth flat cable 1120. A fourth binder 1140 was wrapped in the opposite direction about the tenth flat cable 1130. In the next layer, two flat cables, an eleventh flat cable 1150 and a twelfth flat cable 1155 were wrapped in the opposite direction adjacent to each other. Subsequently a thirteenth flat cable 1160 and a fourteenth flat cable 1165 were wrapped in the same direction in the same layer adjacent to each other. A fifteenth flat cable 1170 adjacent to a sixteenth flat cable 1175 were then wrapped in the same direction about the layer containing the thirteenth flat cable 1160 and the fourteenth flat cable 1165. A fifth binder 1180 was wrapped in the opposite direction about the fifteenth flat cable 1170 and the sixteenth flat cable 1175.

The outer shield 1185 was placed over the fifth binder 1180 and a jacket 1190 extruded over the outer shield 1185. The outer shield 1185 was made by braiding wire at a braiding angle of 21.5° using 24 bobbins and 26 ends at 4.5 picks per inch (2.54 cm).

In this example, the first flat cable 1010, the second flat cable 1020, the third flat cable 1040, the fourth flat cable 1050, the fifth flat cable 1070, the eleventh flat cable 1150, the thirteenth flat cable 1160 and the fifteenth flat cable 1170 were made of 16 individual conductors. The sixth flat cable 1080, the seventh flat cable 1090, the eighth flat cable 1110, the ninth flat cable 1120, the tenth flat cable 1130, the twelfth flat cable 1155, the fourteenth flat cable 1165 and the sixteenth flat cable 1175 were made with 32 individual conductors.

### Example 6

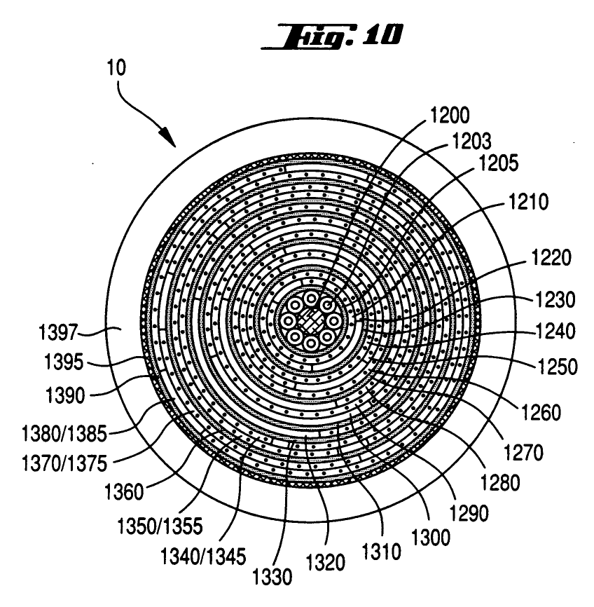

A further example of a cable 10 containing 192 elements according to this construction is shown in FIG. 10.

The spacer 1200 was made of woven Kevlar yarn and had a nominal outside diameter of 0.6±0.1 mm. Eight leads 1203 were placed about the spacer 1200. The leads were made of tin-plated copper conductors of AWG 3601 and had a polyester insulation. A first binder 1205 was placed about the leads. A first flat cable 1210 was wrapped in the opposite direction about the first binder 1205. A second flat cable 1220 was wrapped in the same direction about the first flat cable 1210. A second binder 1230 was wrapped in the opposite direction about the second flat cable 1220. A third flat cable 1240 was wrapped in the opposite direction about the second binder 1230. A fourth flat cable 1250 was wrapped in the same direction about the third flat cable 1240. A fifth flat cable 1260 was wrapped in the same direction about the fourth flat cable 1250. A third binder 1270 was wrapped in the opposite direction about the fifth flat cable 1260. A sixth flat cable 1280 was wrapped in the opposite direction about the third binder 1270. A seventh flat cable 1290 was wrapped in the same direction about the sixth flat cable 1280. An eighth flat cable 1300 was wrapped about the seventh flat cable 1290. A fourth binder 1310 was wrapped in the opposite direction about the eighth flat cable 1300. A ninth flat cable 1320 was wrapped in the opposite direction about the fourth binder 1310. A fifth binder 1330 was wrapped in the opposite direction about the ninth flat cable 1320. In the next layer, two flat cables, a tenth flat cable 1340 and an eleventh flat cable 1345 were wrapped in the opposite direction adjacent to each other. Subsequently a twelfth flat cable 1350 and a thirteenth flat cable 1355 were wrapped in the same direction in the same layer adjacent to each other. A sixth binder 1360 was wrapped in the opposite direction about the twelfth flat cable 1350 and the thirteenth flat cable 1355. A fourteenth flat cable 1370 and a fifteenth flat cable 1375 were subsequently wrapped in the opposite direction about the sixth binder 1360 adjacent to each other. A sixteenth flat cable 1380 and a seventeenth flat cable 1385 were wrapped in the same direction adjacent to each other about the fourteenth flat cable 1370 and the fifteenth flat cable 1375. A seventh binder 1390 was wrapped in the opposite direction about the sixteenth flat cable 1380 and the seventeenth flat cable 1385.

The outer shield 1395 was placed over the seventh binder 1390 and a jacket 1397 extruded over the outer shield 1395. The outer shield 1395 was made by braiding wire at a braiding angle of 29.5° using 16 bobbins and 26 ends at 5 picks per inch (2.54 cm).

In this example, the first flat cable 1210, the second flat cable 1220, the tenth flat cable 1340, the twelfth flat cable 1350, the fourteenth flat cable 1370 and the sixteenth flat cable 1380 were made of 16 individual conductors. The third flat cable 1240, the fourth flat cable 1250, the fifth flat cable 1260 and the sixth flat cable 1280 were made of 24 individual conductors. The seventh flat cable 1290, the eighth flat cable 1300, the ninth flat cable 1320, the eleventh flat cable 1345, the thirteenth flat cable 1355, the fifteenth flat cable 1375 and the seventeenth flat cable 1385 were made with 32 individual conductors.

### Example 7

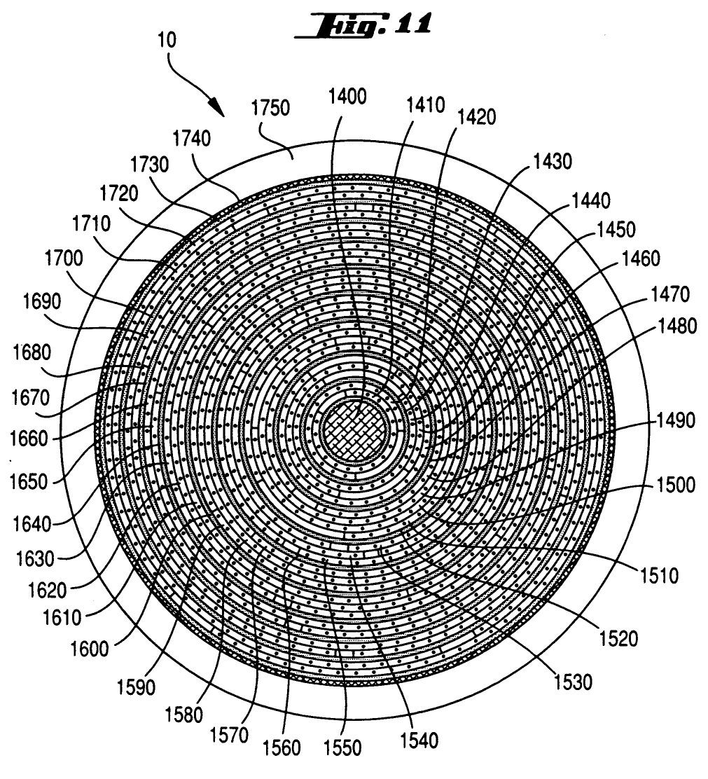

A 600 element cable 10 made in accordance with the invention is depicted in FIG. 11.

The spacer 1400 was made of woven Kevlar yarn over which was extruded a PVC layer. It had a nominal outside diameter of 1.5±0.1 mm. In a first layer 1410, a sixteen conductor flat cable was wrapped about the spacer and in a second layer 1420, a further sixteen conductor flat cable was wrapped in the same direction about the first flat cable. The third layer 1430 had a binder wrapped in the opposite direction about the flat cable in the second layer 1420. The fourth layer 1440, the fifth layer 1450 and the sixth layer 1460 consisted respectively of twenty-four conductor flat cables wrapped in the same direction one layer above each other but in the opposite direction to the third layer 1430. The seventh layer 1470 comprises a binder wrapped in the opposite direction about the sixth layer 1460. The eighth layer 1480, the ninth layer 1490, the tenth layer 1500 and the eleventh layer 1510 comprises thirty-two conductor flat cables wrapped in the same direction one layer on another layer but in the opposite direction to the binder in the seventh layer 1470. The twelfth layer 1520 comprised a binder wrapped in the opposite direction about the eleventh layer 1510. The thirteenth layer 1530 comprises a sixteen conductor flat cable and a twenty-four conductor flat cable wrapped in the opposite direction adjacent to each other about the twelfth layer 1520. The fourteenth layer 1540 and the fifteenth layer 1550 each comprises a sixteen conductor flat cable and a thirty-two conductor flat cable wrapped in the same direction adjacent to each other one layer on another layer. The sixteenth layer 1560 was a binder wrapped in the opposite direction about the fifteenth layer 1550. The seventeenth layer 1570 and the eighteenth layer 1580 each comprises a twenty-four conductor flat cable and a thirty-two conductor flat cable wrapped in the same direction adjacent to each other one layer on the other layer but in the opposite direction to the binder in the sixteenth layer. The nineteenth layer 1590 comprises two thirty-two conductor flat cables wrapped adjacent to each other about the eighteenth layer 1580. About the nineteenth layer 1590, a binder in the twentieth layer 1600 was wrapped in the opposite direction. Each of the twenty-first layer 1610, the twenty-second layer 1620 and the twenty-third layer 1630 comprised two thirty-two conductor flat cables wrapped in the same direction adjacent to each other one on top of each other but in the opposite direction to the binder in the twentieth layer 1600. The twenty-fourth layer 1640 comprises a binder wrapped in the opposite direction about the twenty-third layer 1630. The twenty-fifth layer 1650 and the twenty-sixth layer 1660 each comprised three twenty-four conductor flat cables wrapped in the same direction adjacent to each other one layer on the other but in the opposite direction to the binder in the twenty-fourth layer 1640. The twenty-seventh layer 1670 had a binder wrapped in the opposite direction about the twenty-sixth layer 1660. The twenty-eighth layer 1680 and the twenty-ninth layer 1690 each had two twenty-four conductor flat cables and a thirty-two conductor flat cable wrapped in the same direction adjacent to each other one layer on another layer but in the opposite direction to the binder in the twenty-sixth layer 1660. The thirtieth layer 1700 comprised a binder wrapped in the opposite direction about the twenty-ninth layer 1690. The thirty-first layer 1710 and the thirty-second layer 1720 each had two twenty-four conductor flat cables and a single thirty-two conductor flat cable wrapped in the same direction adjacent to each other one layer on top of another layer but in the opposite direction to the binder in the thirtieth layer 1700. The thirty-third layer 1730 was a binder wrapped in the opposite direction about the thirty-second layer 1720.

An outer shield 1740 was placed over the thirty-third layer and a jacket 1750 extruded over the outer shield 1740. The outer shield 1740 was made by braiding the wire at an angle of 21.8° using 24 bobbins and 39 ends at 3.5 picks per inch (2.54 cm).

### Comparative Example

Comparative results were obtained from a micro-coaxial cable having conductors made of PD135 alloy of AWG 4001. This cable is obtainable from W. L. Gore & Associates GmbH under the designation J14B0596-A.

TABLE 1

| | | | | | | | |
|---|---|---|---|---|---|---|---|
| | | | Insertion Loss @ | Conductor | | | |
| | Impedance | Capacitance | 10 MHz | Resistance | | Torsion | Time Delay |
| Example No. | (Ω) | (pF/ft) | (dB/Assembly) | (Ω/m) | Weight (g/m) | (mNm) | (ns/2.5 m) |

| | | | | | | | |
|---|---|---|---|---|---|---|---|
| Comparative | 49 | 32.0 | | 99.2 | 99.2 | +10/−10 | |
| Example | | | | | | | |
| 3 | 120-128 | 11.6-13.9 | −1.5 | 7.2-8.0 | 57.4 | +50/−10 | 12.0-13.3 |
| 4 | 113-124 | 11.0-13.7 | −1.5 | 7.6-8.2 | 68.3 | | |

The range of results in Table 1 indicate that the measurements were made on different layers within the cable.

### Further Examples

A further embodiment of the invention is conceivable which consists of alternate layers of binder and ribbon cables in concentric arrays. The binders and ribbon cables are wrapped in opposite directions. The ribbon cables are wrapped at slightly different angles in each concentric array so that the electrical conductors do not run parallel to each other over the whole of the electrical signal cable assembly.

Although a few exemplary embodiments of the present invention have been described in detail above, those skilled in the art readily appreciate that many modifications are possible without materially departing from the novel teachings and advantages which are described herein. Accordingly, all such modifications are intended to be included within the scope of the present invention, as defined by the following claims.

1. An electrical signal cable assembly comprising:
at least one ribbon cable arranged in at least one first concentric array around a cylindrical spacer;
a separating concentric element disposed about at least one first concentric array, wherein the separating concentric element is formed from an additional ribbon cable with a plurality of ground conductors connected to an AC ground potential; and
at least one further ribbon cable arranged in at least one further concentric array about the separating concentric element.

2. Electrical signal cable assembly of claim 1 wherein the at least one ribbon cable and the at least one further ribbon cable each have a plurality of electrical conductors and at least one of the plurality of electrical conductors is connectable to an AC ground potential, and at least a further one of the plurality of electrical conductors is connectable to a signal source.

3. Electrical signal cable assembly according to claim 2 wherein at least one of the at least one further concentric arrays comprises two or more ribbon cables adjacent to each other.

4. Electrical signal cable assembly according to claim 3 wherein said two or more ribbon cables are served about the cylindrical spacer.

5. Electrical signal cable assembly according to claim 2 wherein said at least one ribbon cable and at least one further ribbon cable are served about the cylindrical spacer.

6. Electrical signal cable assembly according to claim 1 wherein at least one of the at least one further concentric arrays comprises two or more ribbon cables adjacent to each other.

7. Electrical signal cable assembly according to claim 6 wherein said two or more ribbon cables are served about the cylindrical spacer.

8. Electrical signal cable assembly according to claim 1 wherein at least one of the at least one further concentric arrays comprises two or more ribbon cables adjacent to each other.

9. Electrical signal cable assembly according to claim 8 wherein said two or more ribbon cables are served about the cylindrical spacer.

10. Electrical signal cable assembly according to claim 1 wherein said ribbon cables are served about the cylindrical spacer.

11. Electrical signal cable assembly according to claim 1 wherein an outer shield is disposed about the further concentric array.

12. Electrical signal cable assembly according to claim 11 wherein an outer binder is disposed between the further concentric array and the outer shield.

13. Electrical signal cable assembly according to claim 1 wherein a jacket is disposed about an outside of said electrical signal cable.

14. Electrical signal cable assembly according to claim 1 further including at least one ribbon cable disposed in at least an additional concentric array about the further concentric array and separated form the further concentric array by a further concentric separating element.

15. Electrical signal cable assembly according to claim 14 wherein said further concentric separating element is formed from a further ribbon cable with a plurality of ground conductors connectable to an AC ground potential.

16. Electrical signal cable assembly according to claim 14 wherein said further concentric separating element is formed from a dielectric spacer.

17. Electrical signal cable assembly according to claim 14 wherein at least one of the additional concentric arrays comprises two or more ribbon cables laid adjacent to each other.

18. Electrical signal cable assembly according to claim 14 wherein said further concentric separating element is formed from a ground plane connectable to an AC ground potential.

19. Electrical signal cable assembly according to claim 1 wherein a strain relief is disposed within said first concentric array.

20. Electrical signal cable assembly according to claim 1 wherein the cylindrical spacer is a strength member.

21. Electrical signal cable assembly according to claim 1 wherein the cylindrical spacer is tubular.

22. Electrical signal cable assembly according to claim 1 wherein said cylindrical spacer is constructed from a solid material.

23. Electrical signal cable assembly according to claim 1 wherein said cylindrical spacer is made from a stranded material.

24. Electrical signal cable assembly according to claim 1 further including at least one insulated wire disposed within said cylindrical spacer.

25. Electrical signal cable assembly according to claim 24 wherein an inner cylindrical shield is disposed between said insulated wire and said at least one first concentric array.

26. Electrical signal cable assembly according to claim 1 wherein in insulator of the ribbon cable comprises an upper insulator attached to a lower insulator.

27. Electrical signal cable assembly according to claim 26 wherein said insulator comprises an upper insulator sintered to a lower insulator.

28. Electrical signal cable assembly according to claim 26 wherein said insulator comprises an upper insulator adhered to a lower insulator by an adhesive.

29. Electrical signal cable assembly according to claim 28 wherein said adhesive is selected from the group consisting of thermoplastic adhesives comprising polyester, polyurethane, or fluorinated ethylene propylene.

30. Electrical signal cable assembly according to claim 1 wherein an insulator of the ribbon cable is formed from the group consisting of insulating materials consisting of perfluorakoxy, fluoroethylene propylene, polyester, polyolefin including polyethylene and polypropylene or polymethlypentene.

31. Electrical signal cable assembly according to claim 1 wherein an insulator of the ribbon cable is formed from expanded polytetrafluoroethylene.

32. Electrical signal cable assembly according to claim 1 wherein an insulator of the ribbon cable is formed from full density polytetrafluoroethylene.

33. Electrical signal cable assembly according to claim 1 wherein an insulator of the ribbon cable comprises an extruded polymer.

34. Electrical signal cable assembly according to claim 1 wherein an insulator of the ribbon cable comprises a foamed polymer.

35. Electrical signal cable assembly according to claim 1 wherein the capacitance of the electrical conductors is less than 22 pF/ft (72.2 pF/m).

36. Electrical signal cable assembly according to claim 2 wherein the capacitance of the electrical conductors is less than 15 pF/ft (49.3 pF/m).

37. Electrical signal cable assembly according to claim 1 wherein the time delay of signals passing along a conductor within one of the ribbon cables is less than 5.5 ns/m.
